(19) United States
(12) Patent Application Publication
(10) Pub. No.: US 2007/0198400 A1
(43) Pub. Date: Aug. 23, 2007

(54) USING REMOTE HANDHELD DEVICES FOR BIDDER PARTICIPATION IN COMPUTER-ASSISTED AUCTIONS

(76) Inventors: Bob Schoen, Atlanta, GA (US); Bob Pruett, Morrow, GA (US); Mike Sweeney, Atlanta, GA (US)

Correspondence Address: NIXON & VANDERHYE, PC, 901 NORTH GLEBE ROAD, 11TH FLOOR, ARLINGTON, VA, 22203, US

(21) Appl. No.: 11/671,139

(22) Filed: Feb. 5, 2007

Related U.S. Application Data
(63) Continuation-in-part of application No. 10/882,658, filed on Jul. 2, 2004.
(60) Provisional application No. 60/823,390, filed on Aug. 24, 2006.

(51) Int. Cl. G06Q 40/00

(52) U.S. Cl. 705/37

(57) ABSTRACT

Remote bidding devices such as an RF code tag with no display are used to provide bid inputs at an auction. Handheld devices are associated with bidder identities before the auction begins. To submit a bid, the user presses a bid button on the handheld device A unique code is transmitted from the handheld device and received by the auction system, which interprets the code as a bid.

### CROSS-REFERENCES TO RELATED APPLICATIONS

This application claims the benefit of priority from application No. 60/823,390 filed on Aug. 24, 2006 of Schoen et al. entitled “Using Remote Handheld Devices for Bidder Participation in Computer-Assisted Auctions”. This application is a continuation-in-part of application Ser. No. 10/882,658 filed Jul. 2, 2004 of Schoen et al entitled “Computer-Assisted Method And Apparatus For Absentee Sellers To Participate In Auctions And Other Sales”, now U.S. Pat. No. ______ . The above-referenced applications are incorporated herein by reference as if expressly set forth.

### FIELD

The technology herein relates to computer-assisted transaction management, and more particularly to computer-assisted techniques for selling and/or auctioning goods and/or services. Still more particularly, the technology herein relates to computer-assisted method and apparatus for allowing the seller of particular goods including but not limited to motor vehicles to fully participate in an auction or other sale from a remote location via a data communications or other network, and to techniques allowing dealers and other bidders to bid on cars or other items at auction using remote devices.

### BACKGROUND AND SUMMARY

Auctions provide an efficient way to sell a wide variety of goods including but not limited to motor vehicles, At auction, items are sold to the highest bidder through some type of competitive bidding process. Since an auction sales price is arrived at through competitive bidding, auctions are typically an efficient and appropriate mechanism for valuation of an item for sale. If bidders have confidence in the process, they will willingly submit bids and have confidence the ultimate transaction will yield a good result.

The basic way most auctions work has not changed significantly over the thousands of years that people have been holding auctions. An auctioneer places an item for auction onto the “block” and announces a series of prices (e.g., ascending or descending). A bidder who is interested in purchasing the item makes some type of demonstrative showing (e.g., calling out, raising or waving a hand, winking, raising a bidding card, etc.) when he or she wishes to make a bid at the price the auctioneer is announcing. When the auctioneer is satisfied that no one will make a bidder higher than the current bid, he announces that the item is sold to the current bidder. The bidder is now obliged to purchase the item at the price he or she bid.

At some auctions, dealers raise their hands to indicate they wish to submit a bid at the current price the auctioneer has announced. Many auctions require bidders to raise a bidding card which both indicates that the bidder wishes to make a bid and also unmistakably indicates the bidder's identity so the auctioneer or the auctioneer's clerk can note the identity. At some auctions, so-called “ring men” assist the auctioneer by watching for bids and alerting the auctioneer so the bids can be received and acknowledged, In some auctions, bidding is anonymous or pseudo-anonymous so only the bidder and the auctioneer knows who is submitting a bid.

Recently, some auctions have adopted technology to assist in the auctioning process. One driving force has been the desire to allow remote bidders to bid. In such scenarios, bidders not physically present at the auction (in some cases, the auction has no physical location and proceeds entirely by computer) are enabled to participate in the auction over the Internet or other data communications network. In one exemplary illustrative implementation, bidders use Internet browsers to participate in an auction. Remote bidders submit bids by manipulating their browsers using a mouse or other pointing device or the like. These remote bids are sent to the site of the auction (which may be a computer) where they are acknowledged and registered with the auctioneer. In some such scenarios, remote bidders compete with on-site live bidders. In many other such scenarios, however, there may be no live bidders and all bidders are remotely located. For example, the highly successful eBay auction site provides auctions that are generally run entirely by computer, with remotely located bidders submitting bids by computer over the Internet.

While such online auctions have been highly successful, they are not likely to replace all live auctions—especially for expensive items such as motor vehicles such as cars, trucks, boats and airplanes. However, many live auctions are now integrating an online component—allowing remotely located bidders to participate over a computer network such as the Internet. The bidder may sometimes receive a live auction feed that may include images (moving or still) and sounds (e.g., the auctioneer's voice). For a description of exemplary illustrative non-limiting implementations, see U.S. application Ser. No. 11/296,260 filed Jul. 18, 2005, entitled “Multi-Auction Interface”; and U.S. application Ser. No. 10/882,658 filed Jul. 2, 2004 entitled “Computer-Assisted Method And Apparatus For Absentee Sellers To Participate In Auctions And Other Sales,” both incorporated herein by reference.

In such arrangements integrating live and remote components, one interesting challenge relates to the ability to ensure that remote bidders and on-site bidders are all treated equally. Remote bidders are not likely to participate if they feel that on-site bidders have significant advantages where it counts—acceptance of bids. Even a slight perceived “edge” will often be immediately apparent. In some past scenarios, the different processes used to submit bids from different categories of participants (i.e., remote and on-site) could sometimes result in perceived inequities. For example, in the past before high bandwidth internet connections became widely available, network delays might sometimes have resulted in a remote bidder feeling that he or she would have beaten an on-site bidder if only the computer network had been more responsive. However, now that cable modems and DSL high bandwidth connections are pervasive, the impact of such delays is minimal. In fact, remotely located bidders who are bidding via a computerized process may now sometimes have a responsiveness advantage relative to onsite bidders who need to be recognized through an entirely human process. Since in most auctions each bid submission is in effect a race (the first to submit the bid at that price wins), such timing issues while seemingly minor can occasionally be outcome-determinative, There accordingly is a need for further improvements that may be used to establish absolute equity between different classes of bidders.

Another challenge relates to availability of auction equipment at the site of the auction. Remote bidders commonly use a variety of equipment such as desktop and laptop computers to participate in auctions. Some dealers have invested in personal computers with multiscreen displays and very fast Internet connections to provide excellent auction and bidding interfaces. However, providing any sort of automation equipment to bidders at a live auction can be problematic. For example, typical live automobile auctions are conducted in large open spaces with multiple lanes. Cars move through the lanes as they are auctioned off. Bidders often stand around the lanes to look at the cars and submit their bids. The bidders are typically not sitting at a desk or even sitting at all. Electrical power is generally unavailable to the bidders. The entire dynamic is of a live auction as opposed to bidders submitting bids using a computer. Accordingly, some in the past have determined that end user technology is relatively incompatible with such live auction scenarios.

Others have experimented with allowing local bidders to use high capability handheld devices such as WIFI-connected PocketPCs to receive and display auction information and submit bids. The cost of such equipment can be a significant challenge with such approaches. Expecting bidders to supply their own equipment raises a host of cost, reliability, configuration and other issues. Loaning equipment to bidders for the duration of the auction raises issues such as breakage, inadvertent carrying away of the equipment, theft, and usability. For example, using a PocketPC or Personal Digital Assistant (PDA) as the bidding device may invite theft since such devices are expensive, general purpose and can be used for many different functions other than auction participation—although there may be ways to overcome such problems.

In addition, when remote bidding over the Internet or other network is integrated with a live auction, a certain amount of data automation equipment is needed to provide connectivity, record and report incoming bids, and provide auction feeds to the remote bidders. In the past, this has often restricted these types of auctions to permanent auction installations. Some in the past have configured recreational or other vehicles to provide mobile versions of the auction equipment. It would be desirable to provide additional, more flexible ways to make these types of auctions available at any location such as for example dealer lots, state fairs and other places where people gather and they wish to participate in auctions.

The technology herein provides improvements in the way bidders including dealers can bid on cars or other items at a live auction site.

One non-limiting illustrative exemplary implementation includes an inexpensive, rugged, highly reliable, single purpose handheld bidding device with a control such as a bidding button that sends a unique ID signal wirelessly over a distance. To submit a bid, a bidder simply presses the “bid” button on his or her handheld device. The device sends a “bid” signal which identifies the bidder (device) and distinguishes the bidder (device) from all other bidders (devices), A prior registration process is used to match device IDs with bidder identities so the auctioneer (human and/or electronic) or block clerk/computer knows who is submitting a bid at any given time.

In one exemplary illustrative non-limiting implementation, the handheld bidding device may comprise a radio frequency (RF) code tag with no display. Such a device is inexpensive, rugged, easy to use and has no useful purpose other than participating in an auction—thereby increasing usability, reducing the chance of theft, and increasing the chance that bidders who inadvertently take away a device will return it. Pressing a “bid button” causes the RF ID tag to transmit its RF ID to a receiver where it can be registered as a bid—providing a reliable way to identify the bidder to the auctioneer and other bidders. Such an approach is simple, inexpensive and highly reliable.

Another exemplary illustrative non-limiting implementation provides a somewhat more capable handheld device that connects using a radio communications protocol such as 802.11 WIFI. Such a handheld device may or may not include a display. Connection is provided using existing infrastructure and two-way communication providing a relatively simple but moderately smart handheld device.

Yet another exemplary illustrative non-limiting implementation provides a more capable handheld device with a visual user interface. Such a device may include for example a personal digital assistant (PDA) connectable via a communications protocol such as 802.11 WIFI and providing a browser capability using HTTP. Such a device may receive and process screens for entering auction ID, representative ID and user/password. Another screen can be used for lane information. A further screen may be used showing a person has logged in and showing a bid button. Each auction may be provided with a server and WIFI would be available for all auction lanes.

In still other exemplary illustrative non-limiting implementations, different variations of a handheld bidding device can be used. Any device that is capable of emanating a “bid” signal upon the positive indication of an associated bidder and which can identify the bidder (or be used to ascertain the bidder's identity) may suffice. Such devices can provide one-way or two-way communication, and may or may not include a display. They may or may not include additional handheld controls for inputting additional information.

Another exemplary illustrative non-limiting implementation includes a registration process used to initially match up handheld devices with bidder registrations. A kiosk or other station may be available including automation equipment such as for example a computer, a card reader and a bar code scanner. Each bidder may for example be provided with documentation including a bar code or other easily recognizable and visible bidder ID. An exemplary process may scan a bidder card (which may be for example on the outside of an RFID tag) and associate it with the electronic ID of a bidding device. For example, it is possible to scan a tag in order to confirm/check the tag; if “owned” by a bidder, then associate the tag and a card; if “unowned” by a bidder, then scan card and then associate the tag and card; and log the user into a sale. Tag ownership can expire after a predetermined time period. The registration process can also be used to indicate in the case of bidding agents, who the agents are submitting bids for (in some cases, bidders are buying for multiple principals). Handheld devices can be provided that allow the bidders to indicate which of several principals he or she is submitting the bid for, or bidders can be issued multiple handheld devices with labels to remind the bidder which device to use—or an additional, “offline” bid input process can be used to allow bidders to indicate different principals.

The exemplary illustrative non-limiting implementation can be designed to provide scalability so that many bidders can be accommodated.

In some exemplary illustrative non-limiting implementations, a bidder may still be permitted to submit a hand bid (e.g., if the bidder's bid is rejected because the bidder wasn't signed on from the beginning of the current vehicle sale).

### BRIEF DESCRIPTION OF THE DRAWINGS

These and other features and advantages will be better and more completely understood by referring to the following detailed description of exemplary illustrative non-limiting implementations in connection with the drawings, of which:

FIG. 1 shows an overall exemplary illustrative non-limiting implementation of an auction automation system using remote bidding devices;

FIG. 2 shows an exemplary illustrative non-limiting handheld bidder device;

FIG. 3 is a flowchart of an exemplary illustrative non-limiting auction automation process;

FIG. 4 shows an exemplary illustrative non-limiting implementation of a multi-lane automated auction;

FIG. 5 is a more detailed flowchart of an exemplary illustrative non-limiting auction automation process;

FIG. 6 shows an exemplary illustrative non-limiting process for associating ID tags with bidding registration;

FIGS. 7 shows an exemplary illustrative non-limiting implementation of auction bidding process; and

FIG. 8 shows an exemplary illustrative non-limiting screen displays for handheld bidding devices including display screens.

### DETAILED DESCRIPTION

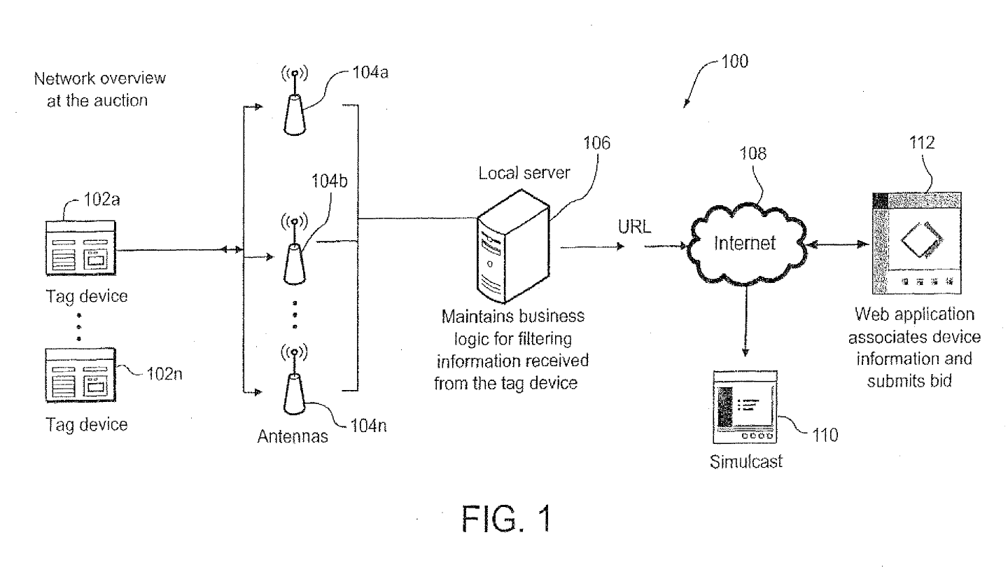

FIG. 1 is a schematic illustration of an exemplary illustrative non-limiting implementation of an auction automation system 100. Auction automation system 100 includes a plurality of tag devices 102a, 102n used by corresponding bidders at the auction. Tag devices 102 may comprise a wide variety of different kinds of devices in different implementations as will be described below. Tag devices communicate wirelessly with auction system 100 in the exemplary illustrative non-limiting implementation via one or more wireless antennas 104a, 104n or other wireless receiving or transceiving equipment. Antennas 104 may, for example, comprise RF ID receivers, 802.11 access points, IR transceivers, or any other desired type of wireless technology. Other implementations may include a combination of wired and wireless technology, or wired technology/connectivity.

A local server 106 receives inputs from antennas 104. The local server 106 in the exemplary illustrative non-limiting implementation maintains business logic for filtering information received from the tag devices 102 to reliably distinguish incoming bids from other messages. Local server 106 may provide a variety of additional auction related functions if desirable, or it may primarily provide connectivity and coordination with the tag devices 102.

The local server 106 in exemplary illustrative non-limiting implementations communicates via the Internet or other network 108 with additional devices including for example remote bidders operating browser based interfaces 110. In the exemplary illustrative non-limiting implementation, a web application 112 associates device information and submits bids. Thus, functionality used at the auction may be provided by a combination of local server 106 and additional computers or other devices coupled to the local server via a real time communications network 108. In addition, the auction may receive inputs from both bidders using tag devices 102 physically located at the auction site, as well as remotely located bidders using web-based or other interfaces 110. See above-referenced copending patent applications for more detail concerning an exemplary auction system architecture using a block computer, an auction display and the like.

In one exemplary illustrative non-limiting implementation, equipment associated with local server 106 may receive and generate audio and video information for streaming via network 108 to remote users 110 to provide a simulcast operation so that bidders connected via the network 108 have the benefit of the sights and sounds of the local auction environment. In some exemplary illustrative non-limiting implementations, a local auctioneer and associated block computer may be located at the local auction site and coupled via local server 108 or other connectivity to drive or assist in driving the auction.

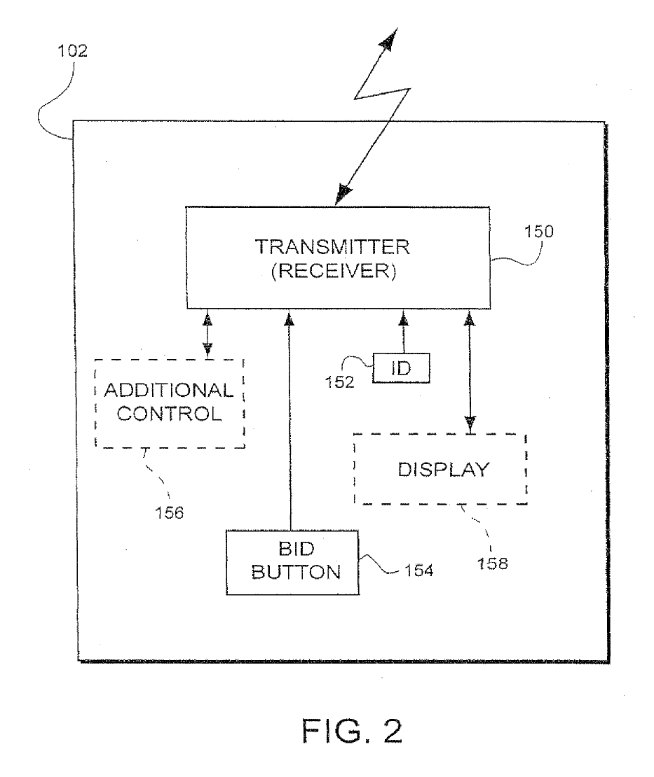

FIG. 2 is a block diagram of an exemplary illustrative non-limiting tag device 102. In the exemplary illustrative non-limiting implementation shown, tag device 102 may include a wireless transmitter or transceiver for communication with local server 106 via antennas 104. In the exemplary illustrative non-limiting implementation, transmitter or transceiver 150 can include for example any type of wireless technology such as RFID tag technology, WIFI technology, WLAN technology, infrared technology, or any type of wireless or wired technology providing connectivity between tag device 102 and local server 106. In one exemplary illustrative non-limiting implementation, each bidder at the auction is issued or otherwise has a tag device 102. Such tag devices are preferably handheld and portable and self-powered, so bidders can walk from one location to another within the auction. Other exemplary illustrative non-limiting implementations could include fixed-position bidding devices located for example at seat positions or on the backs of chairs. However, advantages are provided through a network of remote, portable, handheld tag devices 102,

In the exemplary illustrative non-limiting implementation, each tag device 102 has a unique ID or identifier 152. ID 152 can for example comprise a digital ID value hardwired or stored in a memory within the tag device 102. One exemplary illustrative non-limiting implementation can include a so-called RFID tag comprising a low-cost transmitter that sends ID information on demand. Such RFID devices have become widely used in a variety of different contexts including for example store inventory control, electronic toll gate passes, on the manufacturing floor, interactively connecting polls and other responses for classroom use, and in other contexts. Such devices are relatively inexpensive and provide simple and straightforward functionality of transmitting an identifier on demand. Each tag device can be marked with a unique bar code. In the exemplary illustrative non-limiting implementation, a bid button 154 operable by the bidder is used to actuate the transmitter 150 to send ID 152. Bid button 154 can comprise any type of humanly-actuable control such as for example a push button, a touch screen, or any other electromechanical, mechanical or electrical device by which a bidder can indicate that he or she wishes to submit a bid at the auction.

In operation, a bidder can walk about at will at the auction with the handheld device 102. Since the handheld device is self-powered, portable and wireless, the bidder's movements are not restricted in any way. When a bidder operating handheld tag device 102 wishes to submit a bid, he or she simply presses the bid button 154. In one exemplary illustrative non-limiting implementation, the user does not need to watch any display on the tag device 102 before this operation, and may thus be paying full attention to the ongoing auction. When the user presses the “bid button” 154, this causes the tag device to transmit its unique ID 152. ID 152 is unique among all other tag devices at the auction. Local server 106 receives the transmitted ID and filters it to determine whether it is a bid request or some other message. The local server 106 then associates received bids with bidders, confirms that the handheld device is authorized and is associated with a registered bidder, and then interprets the incoming message as a particular bidder's bid on a particular item on the block at that time. Such bidder identification can be displayed on a main display screen if desired for all other bidders to see. Other bidders can submit bids by similarly pressing their “bid button” 154., The auction ends when a highest bid is received and no further bids are forthcoming.

As shown in FIG. 2, the exemplary illustrative non-limiting tag device 102 may in some implementations further include additional controls 156 to provide additional functionality. An optional display device 158 may be used to display information local server 106 sends back to tag device 102. In some implementations, the communication between tag device 102 and local server 106 is unidirectional, i.e., the only communication that exists is the tag device transmitting an ID to the local server 106. In other exemplary illustrative non-limiting implementations, the local server 106 is able to communicate information back to tag device 102 for processing, display or other indication.

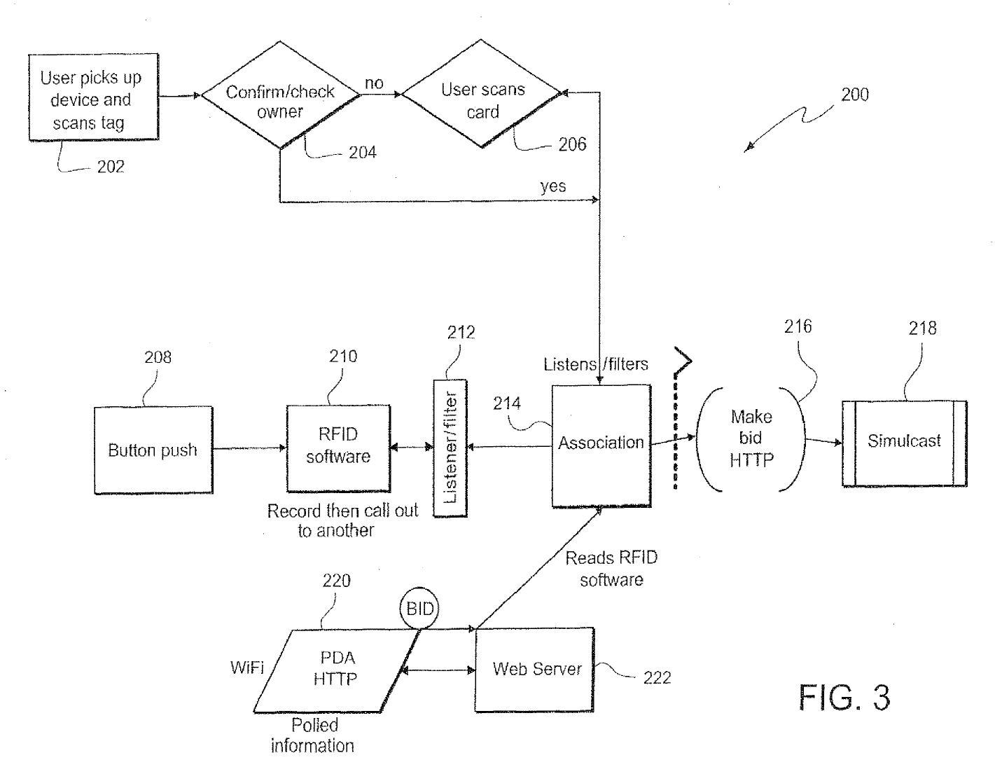

FIG. 3 shows an exemplary illustrative non-limiting implementation of an auction process within the auction system 100 described above. In the FIG. 3 exemplary illustrative non-limiting implementation, a user picks up a tag device 102 at the beginning of the auction and the device is scanned (block 202). At this time, the operator of the auction confirms/checks the user to assure that he or she is qualified to submit bids (block 204). If the user is not already in a bidder database, then a registration process may be performed in which the user supplies information (e.g., by scanning an ID card or other data entry process) that provides the user's identification to the auction authorities (block 206). This process is used to associate particular bidder devices 102 with particular bidders.

If the user wishes to submit a bid, he or she presses the “bid button” 154 on the tag device 102 (block 208). This causes the user's tag device to generate an ID message which is received by antennas 104 and ultimately by local server 106. The local server 106 uses RFID software 210 and listening/filtering technology 212 to discern the ID just transmitted. The local server 106 then uses the previously established association between the user's identify as determined by blocks 204, 206 and the ID 152 of the tag device 102 issued to the user (block 214) to register a bid with a particular bidder. A bar code associated with the RFID tag device can also be scanned to help associate the device with the bidder. Association once registered exists for the duration of the auction such that every time that particular bid button 154 is pushed so that the ID 152 is received via antennas 104 by local server 106, the local server 106 interprets such receipt as a bid submitted by the particular user associated with the tag device.

In one exemplary illustrative non-limiting implementation, other kinds of tag devices 102 including but not limited to personal digital assistants coupled via WIFI or other wireless technology may also be used to submit bids. In such an implementation, a handheld device 102 may be issued a unique ID for use during the auction. When the user operates such a device, information generated via an HTTP or other protocol message is interpreted as a bid and also associated with a particular registered bidder by local server 106. In some exemplary illustrative non-limiting implementations, such HTTP requests may be derived from off-site bidders using a wide variety of devices including personal computers, personal digital assistants, cell phones or any other type of device with remote connectivity via network 108 or other network.

Local server 106 in the exemplary illustrative non-limiting implementation receives and registers bids as described above, and produces bid indications which may then be displayed locally and/or transmitted to a remote location. In one exemplary illustrative non-limiting implementation, local server 106 generates bid indications that are transmitted via the Internet or other network 108 to web application 112 and made available to remote users via simulcast technology (blocks 216, 218).

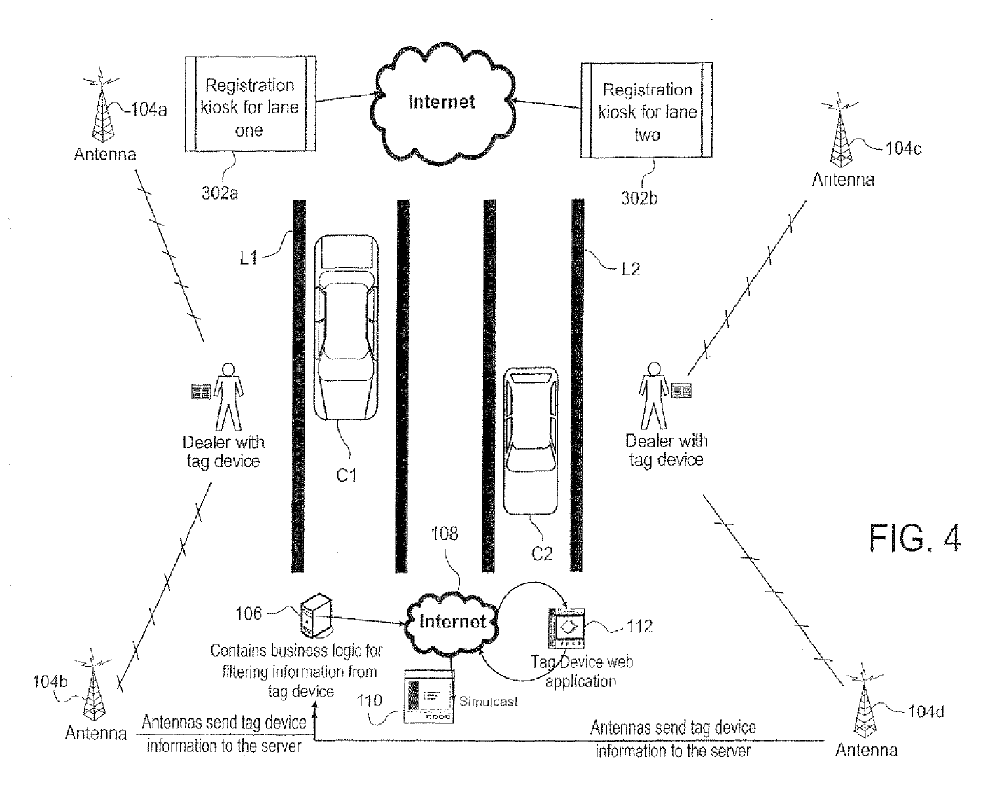

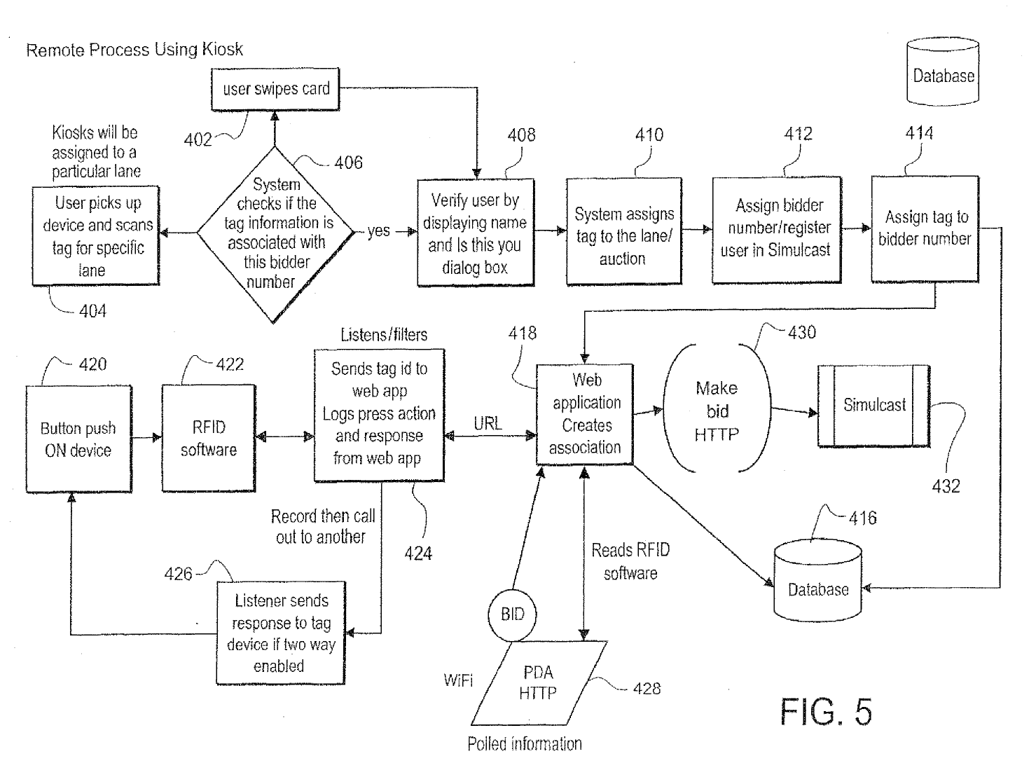

FIG. 4 shows an exemplary illustrative non-limiting multi-lane auction topography, and FIG. 5 shows an exemplary illustrative non-limiting implementation of a registration process used for multiple lane auctions. In a multiple lane auction, several auctions may be performed at the same auction site. For example, at automobile auctions, often there are multiple auctioneers and multiple blocks with different auctions proceeding all simultaneously. In the FIG. 4 example, a kiosk 302 is provided for each lane of the auction. Such a registration kiosk 302 has equipment that allows a user to swipe or otherwise read an identification card (FIG. 5, block 402). At the kiosk, the user may also pick up a tag device 102 which is assigned to a particular lane and scanned (e.g., by a barcode reader) for association with the bidders identity (block 404). In response to such actions, the system checks if the tag information is associated with (“owned” by) this bidder (block 406). If not, the user is asked to identify himself or herself, often by swiping an identification card or the like (block 402). In either case, the system verifies the user by displaying his or her name and asks “is this you?” (block 408). If the answer is confirmed, the system assigns the tag to the particular lane/auction (block 410) and assigns a bidder number/register user in the simulcast auction to occur (block 412). The system also assigns a tag to a bidder number (block 414). Such assignment or association is stored within a database 416 and is also used by web applications 112 to create an association (block 418). Such associations can expire automatically after a certain amount of time has elapsed.

During the auction, when a user pushes bid button 154 (block 420), RFID software (block 422) is used to communicate the device ID 152 to the local server 106. In such case, the local server and/or other equipment filters inputs to detect bids intended for the particular lane the server is concerned with. The local server 106 in turn sends a received tag ID to the web application 112 and logs the “press” action and response if any, from the web application (block 424). The local server 106 may also send a response to the tag device 102 if the tag device is capable of bidirectional communications and such bidirectional communications is enabled (block 426). Meanwhile, the web application may communicate with personal digital assistants or other types of portable handheld devices to receive additional bids via HTTP or other communications protocols (block 428). Once the web application 112 determines that a bid has been submitted, it may send a “make bid” message to the simulcast auction server which in the exemplary illustrative non-limiting implementation handles competitive bidding (blocks 430, 432).

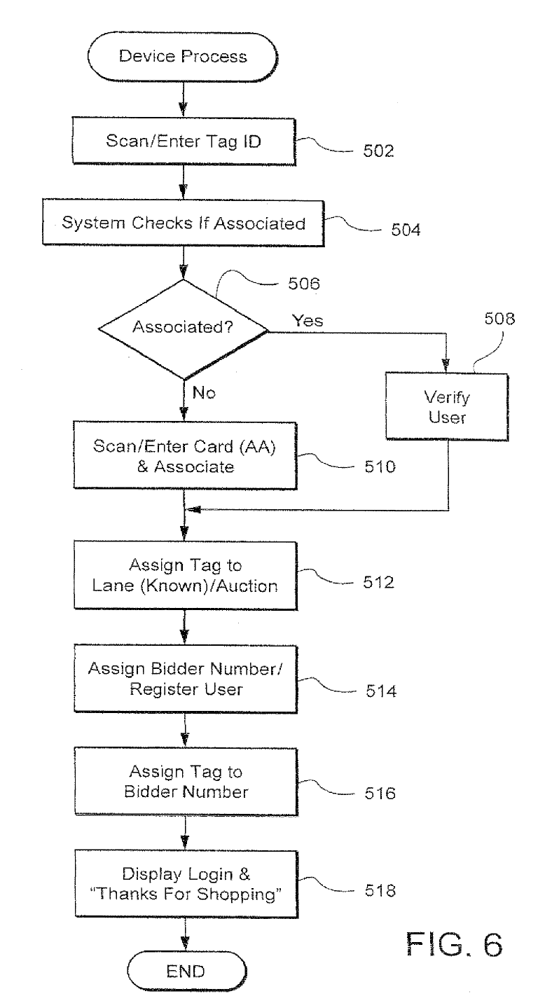

FIG. 6 shows an exemplary illustrative more detailed process for associating tag devices 102 with bidders. In the exemplary illustrative non-limiting implementation shown, an ID associated with the tag device 102 is scanned or otherwise entered via bar code scanner, or any other technique can be used (block 502). The system checks if this ID is unique and has already been associated with a user (block 504). If there is association (“yes” exit to decision block 506), then the system verifies the user 508. Otherwise (“no” exit to decision block 506), the user is asked to identify himself or herself by presenting an identification card such as a bidding card which can be scanned in order to associate with the RFID tag (block 510). Once there has been association between a user and a tag ID, the system may then assign the tag to a lane or to the auction (block 512). The system may also assign the bidder a bidder number and register the user for the auction (block 514). The system assigns the tag to the bidder number (block 516) and may display a login and “thanks for shopping” indication (block 518).

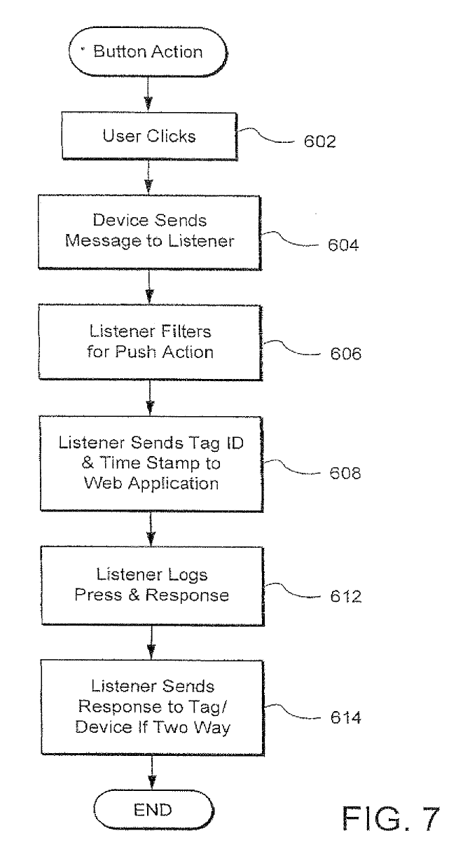

FIG. 7 shows an exemplary illustrative non-limiting implementation of a process performed by a tag device 102 upon depression by the bidder of the bid button 154. In the exemplary illustrative non-limiting implementation, when the user clicks on the bid button 154, the handheld device 102 sends a message to a listener 604 via antennas 104 or other communications means. The listener filters received information for push actions (block 606), and then, upon discerning that a push action has been received, sends the tag ID and time stamp to the web application 112 (block 608). The listener logs the button press and may send a response if the handheld device 102 is two-way enabled (block 612, 614).

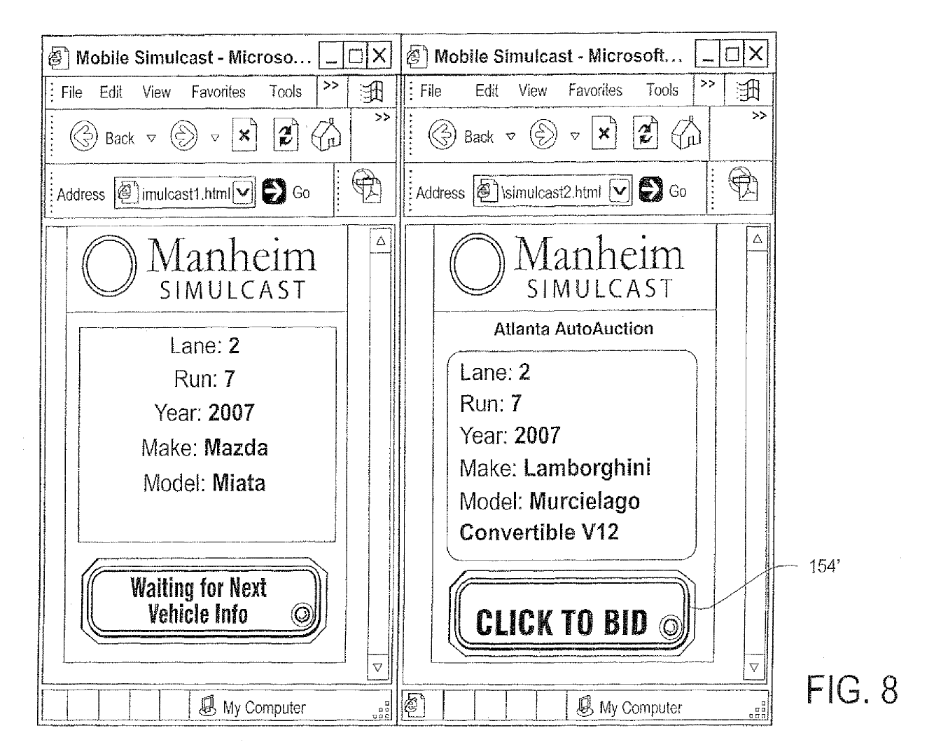

FIG. 8 shows exemplary illustrative non-limiting implementations of screen displays that can be displayed on certain types of handheld devices 102. In the example shown, such screens may include a variety of informational legends describing the item currently up for bid and a “click to bid” bid button 154′. A user may use a conventional user interface such as a touch screen, a touch pad or any other type of control to actuate the “click to bid” button to cause device 102 to send an associated unique ID indicating that this particular user wishes to bid on the item currently being auctioned.

While the technology herein has been described in connection with exemplary illustrative non-limiting implementations, the invention is not to be limited by the disclosure. The invention is intended to be defined by the claims and to cover all corresponding and equivalent arrangements whether or not specifically disclosed herein.

1. A method of submitting bids in an auction comprising:
registering bidding devices in association with bidders, each bidding device including at least a user-actuable control that causes the bidding device to wirelessly emit an identifier;
receiving wirelessly emitted identifiers during an auction;
in response to said received wirelessly emitted identifiers, looking up associated bidder identities in a database and accepting a corresponding bid associated with the identified bidders; and
allowing other bidders to ascertain identities of bidders submitting bids during said auction.

2. The method of claim 1 further including issuing portable battery-operated bidding devices to said bidders.

3. The method as in claim 2 wherein said portable bidding devices include an RFID tag and a bid button.

4. The method as in claim 2 wherein said bidding devices do not include a display.

5. The method as in claim 1 wherein said bidding devices include a display.

6. The method as in claim 1 wherein said bidding devices provide unidirectional wireless communications.

7. The method as in claim 2 wherein said bidding devices provide bidirectional wireless communications.

8. The method as in claim 2 wherein said bidding devices each include an electronic identifier and are marked with a further identifier ascertainable using the naked eye.

9. The method as in claim 1 wherein said registering is provided for each lane of a multi-lane auction to thereby register bidders to specific auction lanes.

10. An auction bidding device comprising:
a housing;
a radio frequency identification microchip; and
a user-actuable control coupled to said microchip, said user-actuable control controlling said microchip to wirelessly emit electromagnetic radiation encoding a unique identifier,
wherein said bidding device is issued to a bidder at the beginning of an auction and is collected at the end of the auction.
